(19) United States
(12) Patent Application Publication
(10) Pub. No.: US 2016/0310913 A1
(43) Pub. Date: Oct. 27, 2016

(54) FLEXIBLE TWO-DIMENSIONAL SINGLE-LAYER SUPRAMOLECUALR POLYMER TOWARD PRECISE NANO-SIZE SEPARATION

(71) Applicants: Lixin Wu, Changchun (CN); Liang Yue, Changchun (CN); Shan Wang, Changchun (CN); Bao Li, Changchun (CN)

(72) Inventors: Lixin Wu, Changchun (CN); Liang Yue, Changchun (CN); Shan Wang, Changchun (CN); Bao Li, Changchun (CN)

(21) Appl. No.: 14/849,616

(22) Filed: Sep. 10, 2015

(30) Foreign Application Priority Data
Apr. 23, 2015 (CN) 201510197137.5

(51) Int. Cl. B01D 71/80; C08B 37/16

(52) U.S. Cl. CPC B01D 71/80; C08B 37/0015

(57) ABSTRACT

The disclosure regards to the porous materials, concerning a flexible 2D single-layer supramolecular polymer and its application in precise nano size separation. It comprises the synthesis of a bolaform cationic molecule, preparation of a cationic bridging stick, a flexible 2D single-layer supramolecular polymer and supramolecular polymer membrane, and the application of the membrane in precise nano-size separation. A synergetic ionic self-assembly approach which is facile, convenient and based on the ionic bond without preferential direction is used to construct a flexible 2D single-layer supramolecular polymer. Furthermore, its distinctive properties such as uniform nanoporous structure and flexibility offer an unprecedented opportunity to fabricate ultrafiltration membrane towards precise nanosize separation.

### STATEMENT REGARDING FEDERALLY SPONSORED RESEARCH

This invention was made with financial support from National 973 Program of China (2013CB834503), National Natural Science Foundation of China (91227110, 21221063), and the Ministry of Education of China (20120061110047).

### TECHNICAL FIELD

This invention refers to the methods for producing porous materials, such as porous supramolecular polymers, a flexible two-dimensional (2D) single-layer supramolecular polymer produced thereof, and the use of the membranes prepared from the supramolecular polymer for various applications, including nano-size separation, selective transport, molecular separation and dialysis systems.

### BACKGROUND

The reported known porous materials are porous organic supramolecular polymers and metal organic frameworks (MOFs), but both fields for membrane application meet inevitable barriers, that is, the porosity of supramolecular polymers is inadequate regular and the crystalline solid of metal organic framework often leads to hard processing. The ionic supramolecular self-assembly comprised of small molecular building blocks has proved to be a more promising approach to combine the whole advantages in the control of identical porosity and good processability for the membrane application. However, the non-saturation and non-preferential direction features of ionic bond results in a major difficulty in the well-defined structural control of self-assemblies.

### SUMMARY

The following disclosure presents a novel method to produce a flexible 2D single-layer supramolecular polymer through ionic bond which has not been previously presented. Furthermore, the disclosure provides characterizations of the flexible 2D single-layer supramolecular polymers, and their application in precise nano-size separation.

The disclosure provides a flexible 2D single-layer supramolecular polymer comprising the general structure [L]²⁺[POM]⁴⁻[L]²⁻, wherein POM is a polyoxometalate, and L is a bridging sick which comprises a host α-cyclodextrin (CD) and Formula I (bolaform cationic molecule):

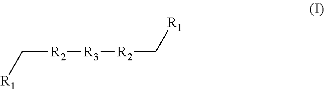

Wherein, R₁ is a cationic group; R₂ is a guest group; R₃ is a linker.

In an embodiment, POM is a Keggin-type polyoxometalate or a polyoxometalate with similar size, which has four negative charges, for example [SiW₁₂O₄₀]⁴⁻, [SiMo₁₂O₄₀]⁴⁰⁻, [SiW₁Mo₁₁O₄₀]⁴⁻, [SiW₂Mo₁₀O₄₀]⁴⁻, [SiW₃Mo₉O₄₀]⁴⁻, [SiW₄Mo₈O₄₀]⁴⁻, [SiW₆Mo₆O₄₀]⁴⁻, [SiW₁₁Mo₁O₄₀]⁴⁻, [SiW₁₀Mo₂O₄₀]⁴, [SiW₉Mo₃O₄₀]⁴, [GeW₁₂O₄₀]⁴, [GeMo₁₂O₄₀]⁴, [PW₁₁VO₄₀]⁴, [PMo₁₁VO₄₀]⁴, α-[PW₁₁O₃₉Cr^{III}(H₂O)]⁴⁻, α-[PW₁₁O₃₉Cr^{III}(H₂O)]⁴⁻, α-[PW₁₁O₃₉Cr^{V}O]⁴⁻, α-[PW₁₁O₃₉Mn^{III}(H₂O)]⁴⁻, α-[PW₁₁O₃₉Co^{III}(H₂O)]⁴⁻, α-[PW₁₁O₃₉Co^{III}(pyridine)]⁴⁻. In yet an embodiment, the cation of the POM is proton, ammonium or alkali metal ion. In a further embodiment, POM is either K₄[PW₁₁VO₄₀] or H₄[PMo₁₁VO₄₀]. In another embodiment, R₁ is selected from —NH₃⁺, —[NH₂(CH₃)]⁺, —[NH(CH₃)₂]⁺,

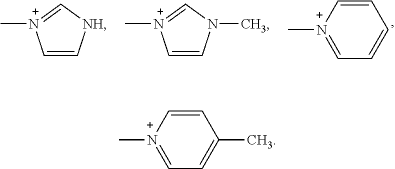

In yet another embodiment, the counter ion of the R₁ is selected from Cl⁻, Br³¹ , I⁻, PF₆⁻.

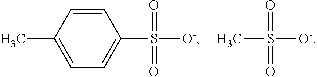

In yet a further embodiment, R₁ is

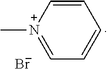

In an embodiment, R₂ is selected from

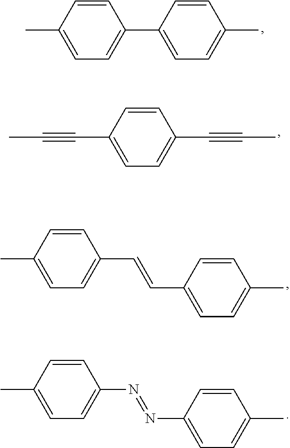

In yet an embodiment, R₂ is

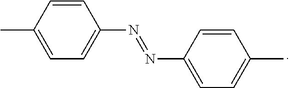

In another embodiment, R₃ is selected from

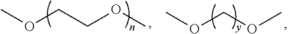

wherein n is a number from 0 to 7 and y is a number from 0 to 14. In yet another embodiment, R₃ is

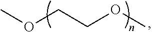

wherein n is a number either 3 or 4. In an embodiment, the linker increases the flexibility of the 2D single-layer supramolecular polymers. In yet an embodiment, CD blocks the possible aggregation and controls the space adaptation of four bolaform cationic molecule around one POM in a 2D plane. In yet a further embodiment, CD increases the solubility of the 2D single-layer supramolecular polymer in water.

The disclosure also provides a method of making the flexible 2D single-layer supramolecular polymer as described above comprising a reaction at RT comprising water, POM, and a bridging sick which comprises a reaction at RT comprising water, CD and Formula I (bolaform cationic molecule) under sonication:

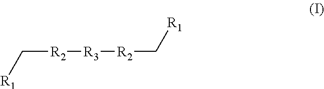

Wherein, R₁ is a cationic group; R₂ is a guest group; R₃ is a linker.

### BRIEF DESCRIPITION OF FIGURES

The accompanying Figures, which are incorporated into and constitute a part of this specification, illustrate one or more embodiments of the disclosure and, together with the detailed description, serve to explain the principles and implementations of the disclosure.

FIG. 1 provides the ¹H nuclear magnetic resonance spectra (¹H-NMR) (a) and electrospray ionisation mass spectrometry (ESI-MS/MS) (b) of Azo-TrEG.2Br.

FIG. 2 provides the ¹H-NMR (a) and ESI-MS/MS (b) spectra of Azo-TeEG.2Br.

FIG. 3 provides the ¹H-NMR (a) and ESI-MS/MS (b) spectra of Azo-TrEG@CD.2Br.

FIG. 4 provides the ¹H-NMR (a) and ESI-MS/MS (b) spectra of Azo-TeEG@CD.2Br.

FIG. 5 provides the atomic force microscopic (AFM) image (a) and height profile (b) of the AFM image of the supramolecular polymer [Azo-TrEG@CD] [PWV].

FIG. 6 provides the AFM image (a) and height profile (b) of the AFM image of the supramolecular polymer [Azo-TeEG@CD] [PWV].

FIG. 7 provides the high resolution transmission electron microscopic (HRTEM) images of the 2D single-layer supramolecular polymer [Azo-TrEG@CD] [PWV]: (a) wide and (b) amplified scale, while the insert presents a much higher amplified image taken from the same sample.

FIG. 8 provides the HRTEM images of the 2D single-layer supramolecular polymer [Azo-TeEG@CD] [PWV], while the insert presents a much higher amplified image taken from the same sample.

FIG. 9 provides the X-ray diffraction (XRD) patterns of the 2D single-layer supramolecular polymer [Azo-TrEG@CD] [PWV] of (a) the powdered sample prepared by solution freeze-drying and (b) the film sample prepared by solution filtration.

FIG. 10 provides the photographs of (a) as-prepared Tr-membrane on polycarbonate filter and (b) the isolated Tr-membrane obtained through drying in oven at 40° C. for 48 h and dissolving polycarbonate supporting filter in chloroform.

FIG. 11 provides the fluorescence spectra and photographs under 365-nm light irradiation of the QDs mixture solution (1) before (a) and after (b) filtering through Tr-membrane.

FIG. 12 provides the HRTEM images of the QDs mixture solution (1) before (a) and after (b) filtering through Tr-membrane.

FIG. 13 provides the fluorescence spectra and photographs under 365-nm light irradiation of the QDs mixture solution (2) before (a) and after (b) filtering through Tr-membrane.

FIG. 14 provides the fluorescence spectra and photographs under 365-nm light irradiation of the QDs mixture solution (3) before (a) and after (b) filtering through Tr-membrane.

FIG. 15 provides the fluorescence spectra and photographs under 365-nm light irradiation of the QDs solution (4) before (a) and after (b) filtering through Tr-membrane.

FIG. 16 provides the fluorescence spectra and photographs under 365-nm light irradiation of the QDs solution (5) before (a) and after (b) filtering through Tr-membrane.

FIG. 17 provides the fluorescence spectra and photographs under 365-nm light irradiation of the QDs solution (6) before (a) and after (b) filtering through Tr-membrane.

FIG. 18 provides the fluorescence spectra and photographs under 365-nm light irradiation of the QDs solution (7) before (a) and after (b) filtering through Tr-membrane.

FIG. 19 provides the ultraviolet-visible (UV-vis) spectra and photographs of the rhodamine B solution before (a) and after (b) filtering through Tr-membrane, both solutions diluted twice for the ultraviolet-visible test.

FIG. 20 provides the UV-vis spectra and photographs of the xylenol orange solution (pH=3.8) before (a) and after (b) filtering through Tr-membrane, both solutions diluted fourth for the UV-vis test.

FIG. 21 provides the UV-vis spectra and photographs of the xylenol orange solution (pH=7.9) before (a) and after (b) filtering through Tr-membrane, both solutions diluted fourth for the UV-vis test.

FIG. 22 provides the matrix-assisted laser desorption/ionization time-of-flight (MALDI-TOF) mass spectrometry of the mixture of α-CD, β-CD and γ-CD before (a) and after (b) filtering through Tr-membrane.

FIG. 23 provides the fluorescence spectra of the QDs solution (4) before (a) and after (b) filtering through Te-membrane.

FIG. 24 provides the fluorescence spectra of the QDs mixture solution (1) before (a) and after (b) filtering through Te-membrane.

FIG. 25 provides the fluorescence spectra and photographs under 365-nm light irradiation of the QDs solution (7) before (a) and after (b) filtering through Te-membrane.

FIG. 26 provides the fluorescence spectra and photographs under 365-nm light irradiation of the QDs mixture solution (8) before (a) and after (b) filtering through Te-membrane.

### DETAILED DESCROPITION

As used herein and in the appended claims, the singular forms “a” and “the” include plural referents unless the context clearly dictates otherwise. Thus, for example, reference to “a polyoxometalate” includes a plurality of such polyoxometalates and reference to “the membrane” includes reference to membranes producing from the process disclosed herein.

Also, the use of “or” means “and/or” unless stated otherwise. Similarly, “comprise”, “comprises”, “comprising”, “include”, “includes” and “including” are interchangeable and not intended to be limited.

It is to be further understood that where descriptions of various embodiments use the term “comprising”, those skilled in the art would understand in some specific instances, an embodiment can be alternatively described using language “consisting essentially of” or “consisting of”.

Unless defined otherwise, all technical and scientific terms used herein have the same meaning as commonly understood to one of ordinary skill. Although methods and materials similar or equivalent to those described herein can be used in the practice of the disclosed methods and compositions, the exemplary methods, devices and materials are described herein.

All publications mentioned herein are incorporated herein by reference in full for the purpose of describing and disclosing the methodologies, which are described in the publications, which might be used in connection with the description herein. The publications discussed above and through the text are provided solely for their disclosure prior to the filing date of the present application. Nothing herein is to be construed as an admission that the inventors are not entitled to antedate such disclosure by virtue of prior disclosure. Moreover, with respect to similar or identical terms found in the incorporated references and terms expressly defined in this disclosure, the term definitions provided in this disclosure will control in all respects.

The term “polyoxometalate” or “POM” refers to a kind of discrete metal-oxide polyanionic clusters that comprises three or more transition metal oxyanions linked together by sharing oxygen atoms and displays a large structural variety, such as Lindqvist, Anderson, Keggin and Dawson-type structures. And in the construction of the IOF, the anionic polyoxometalate acts as the connecting node. As for the Keggin-type POM, it refers to the POM with Keggin structure which comprises a general formula of [XM₁₂O₄₀]^{m}, where X is the heteroatom (most commonly are P⁵⁺, Si⁴⁺, Ge⁴⁺ or B³⁺), M is the addenda atom (Mo, W, V, Cr, Fe, Mn or Co), and O represents oxygen. The heteroatom is surrounded by four oxygens to form a tetrahedron, located centrally and caged by 12 octahedral Mo₆-units which linked to one another by the neighboring oxygen atoms.

The term “charge number” refers to the number of the negative charge of a POM or the cations that bind to a central POM through ionic bond.

The term “ionic bond” refers to a type of chemical bond that involves the electrostatic attraction between oppositely charged ions and possesses the features of non-saturation and non-preferential direction, which can bring the flexibility for the self-assembled IOF.

The term “pseudorotaxane” refers to a supramolecular species consisting of a linear molecular component encircled by a macrocyclic component, but in which the linear component does not have bulky end groups. And in the construction of the IOF, the cationic pseudorotaxane acts as the bridging stick.

The term “ionic supramolecular self-assembly” refers to a well-defined aggregate in which small molecular building blocks hold together by ionic bonds without guidance or management from an outside source.

The term “supramolecular polymer” refers to a self-assemble polymer consisting of plurality of connecting node and bridging stick to form one-, two-, or three-dimensional polymers which may or may not be porous based on noncovalent interaction.

The term “separation efficiency” refers to a separation efficiency of QDs carried out by evaluating relative fluorescence intensity of filtrates before and after filtering at the maximum emission wavelength.

The flexible 2D single-layer supramolecular polymer is generated from a bridging stick comprising CD and Formula I (bolaform cationic molecule):

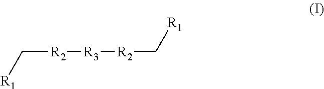

Wherein, R₁ is a cationic group and selected from —NH₃⁺, —[NH₂(CH₃)]⁺, —[NH(CH₃)₂]⁺, —[N(CH₃)₃]⁺,

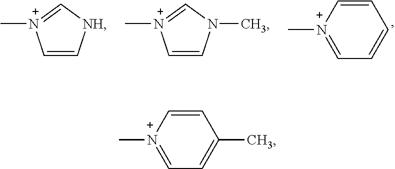

and the counter ion of the R₁ is selected from Cl⁻, Br⁻, I₃₁ , PF₆,

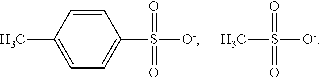

R₂ is a guest group and selected from

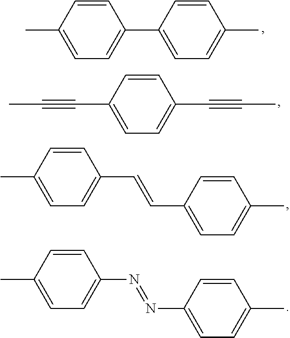

R₃ is a linker and selected from

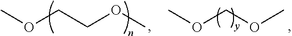

wherein n is a number from 0 to 7 and y is a number from 0 to 14.

In order to obtain a cross-linking supramolecular polymer, bolaform cationic molecules comprising that two cationic heads on both sides can perform as a bridging stick to bind with polyanions are designed. In an embodiment, the bolaform cationic molecule comprises R₁ (cationic pyridine groups:

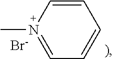

R₂ [azobenzene (Azo) groups:

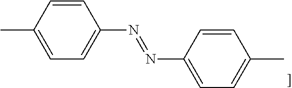

and R₃ [ethylene glycol (EG) group:

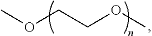

wherein n is a number of either 3 or 4], and the corresponding bolaform cationic molecule is either Azo-TrEG.2Br or Azo-TeEG.2Br, respectively.

The preparation of the bridging stick of the disclosure can be carried out by mixing the bolaform cationic molecule with CD in water at RT under sonication (100 W). In an embodiment, the concentration of the bolaform cationic molecule is from 0.008 to 0.100 mM. In another embodiment, the molar ratio of bolaform cationic molecule and CD is from 1:2 to 1:5. In yet a further embodiment, the sonication time is from 10 to 60 min. In yet a still further embodiment, when the number of EG groups is either 3 or 4, the corresponding bridging stick (the cationic pseudorotaxane) is either Azo-TrEG@CD.2Br or Azo-TeEG@CD.2Br, respectively.

The preparation of the 2D single-layer supramolecular polymer of the disclosure can be carried out by mixing the cationic pseudorotaxane solution with polyanion POM solution with the same volume through ionic bond at RT under aging process. In an embodiment, the concentration of the cationic pseudorotaxane solution is from 0.008 to 0.100 mM. In another embodiment, POM is a Keggin-type polyoxometalate or a polyoxometalate with similar size, which has four negative charges, and selected from [SiW₁₂O₄₀]⁴⁻, [SiMo₁₂O₄₀]⁴⁻, [SiW₁Mo₁₁O₄₀]⁴⁻, [SiW₂Mo₁₀O₄₀]⁴⁻, [SiW₃Mo₉O₄₀]⁴⁻, [SiW₄Mo₈O₄₀ ]⁴⁻, [SiW₆Mo₆O₄₀]⁴⁻, [SiW₁₁Mo₁O₄₀]⁴⁻, [SiW₁₀Mo₂O₄₀]⁴⁻, [SiW₉Mo₃O₄₀]⁴⁻, [GeW₁₂O₄₀]⁴⁻, [GeMo₁₂O₄₀]⁴⁻, [PW₁₁VO₄₀]⁴⁻, [PMo₁₁VO₄₀]⁴⁻, α-[PW₁₁O₃₉Cr_{III}(H₂O)]⁴⁻, α-[PW₁₁O₃₉Cr^{III}(H₂O)]⁴⁻, α-[PW₁₁O₃₉Cr^{V}O]⁴⁻, α-[PW₁₁O₃₉Mn^{III}(H₂O)]⁴⁻, α-[PW₁₁O₃₉Co^{III}(H₂O)]⁴⁻, α-[PW₁₁O₃₉Co^{III}(pyridine)]⁴⁻. In yet an embodiment, the cation of the POM is proton, ammonium or alkali metal ion. In a further embodiment, POM is either K₄[PW₁₁VO₄₀] (PWV) or H₄[PMo₁₁VO₄₀] (PMoV). In a further embodiment, the molar ratio of the concentration of the polyanion POM solution and that of cationic pseudorotaxane solution is from 0.5 to 0.7. In yet a further embodiment, the aging process is to make the 2D single-layer supramolecular polymer grow up and the aging time is from 0.03 to 12 h. In yet a still further embodiment, when the number of EG groups is either 3 or 4, the corresponding 2D single-layer supramolecular polymer is either [Azo-TrEG@CD]₂[PWV] or [Azo-TeEG@CD]₂[PWV], respectively.

In one embodiment, the flexibility of the 2D single-layer supramolecular polymer is provided by the feature of the ionic bond and the EG groups.

In one embodiment, the pore aperture of the 2D single-layer supramolecular polymer is controlled by the length of the EG groups.

The uniform mesh-like structure and the flexibility of the 2D single-layer supramolecular polymer in aqueous solution simplify the fabrication of nanoporous membrane to a facile suction filtration procedure under a slightly reduced pressure. For example, the nanoporous membrane is prepared by the filtration of the 2D single-layer supramolecular polymer solution on a supporting filter under a slightly reduced pressure at a constant filtration rate. In an embodiment, the concentration of the 2D single-layer supramolecular polymer solution is from 0.017 to 0.216 mg mL⁻¹. In another embodiment, the supporting filter is an aqueous membrane with pore size from 100 to 400 nm, but with no limitations to its material. In a further embodiment, the area of the supramolecular polymer membranes is not restricted and the supramolecular polymer membranes can be prepared in any shape and size. In yet an embodiment, the constant filtration rate is from 4 to 10 mL min⁻¹. In yet a further embodiment, under the case keeping highly even spreading, the thickness of the supramolecular polymer membranes is also unlimited and thinner membranes are favorable for increasing the separation efficiency. In yet a still further embodiment, when the number of EG groups is either 3 or 4, the corresponding membrane based on the supramolecular polymers (either [Azo-TrEG@CD]₂[PWV] or [Azo-TeEG@CD]₂[PWV], respectively) is either Tr-membrane or Te-membrane, respectively.

The prepared supramolecular polymer membranes possessing uniform mesh-like structure with adjustable pore aperture can be used for precise nano-size separation with quantum dots (QDs), dye molecules, biological molecules, metal nanoparticles, semiconductor nanoparticles, graphene quantum dots or POM complexes, the smaller size of which can pass through the supramolecular polymer membrane (see Examples).

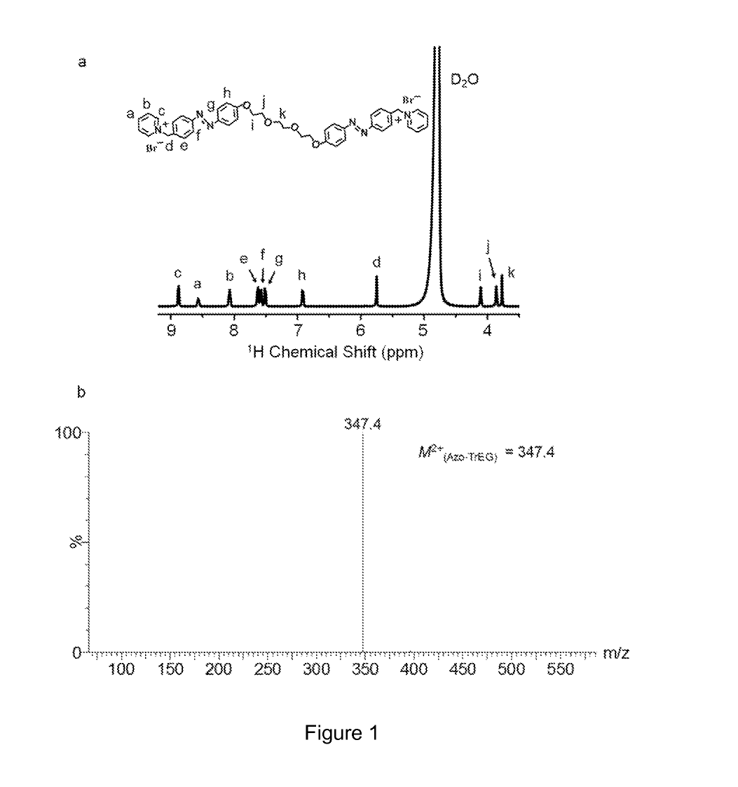

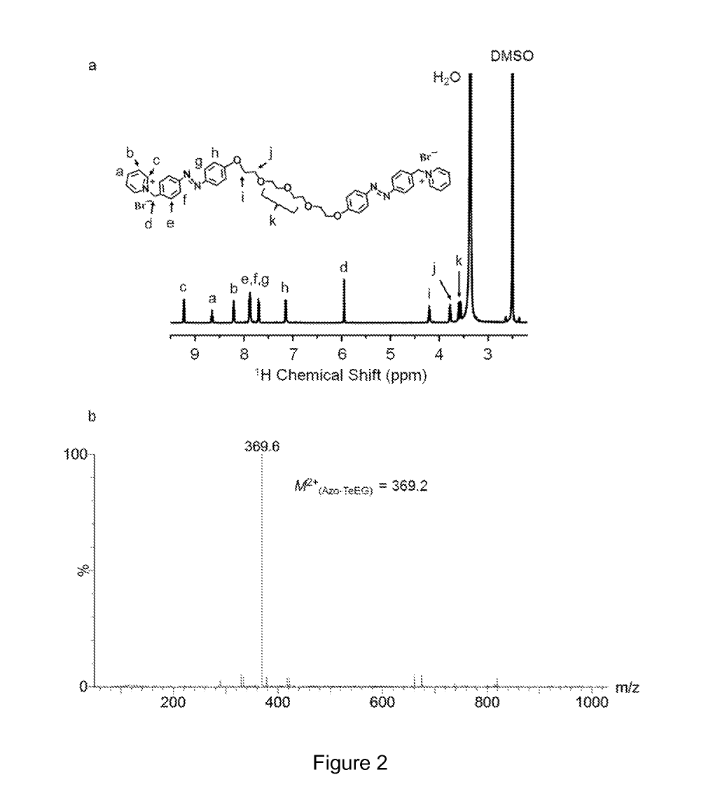

The bolaform cationic molecules (Azo-Tr/TeEG.2Br) comprised of two cationic azobenzene (Azo) groups connecting by EG groups with the number of either 3 or 4 were synthesized (see Examples) and their chemical structures were characterized by ¹H-NMR and ESI-MS/MS spectra (FIGS. 1 and 2), indicating successful synthesis of the bolaform cationic molecules Azo-Tr/TeEG.2Br.

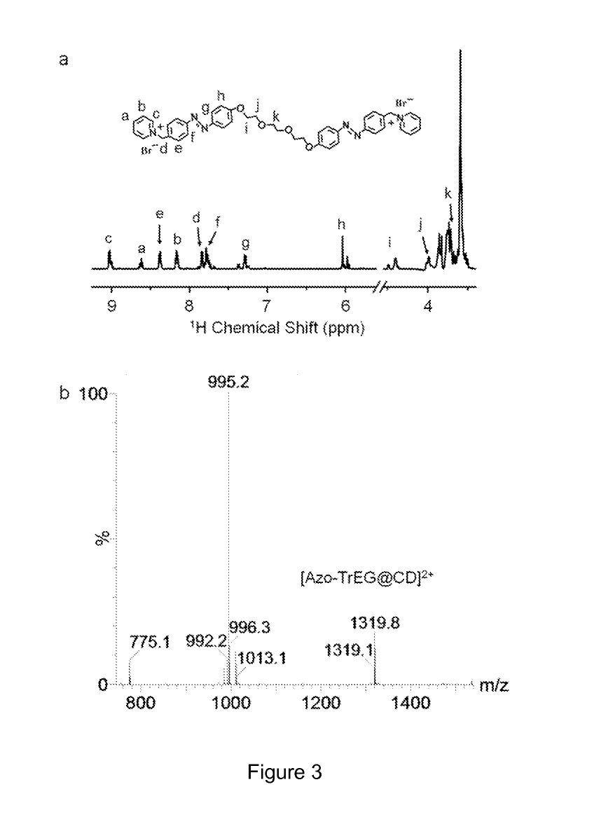

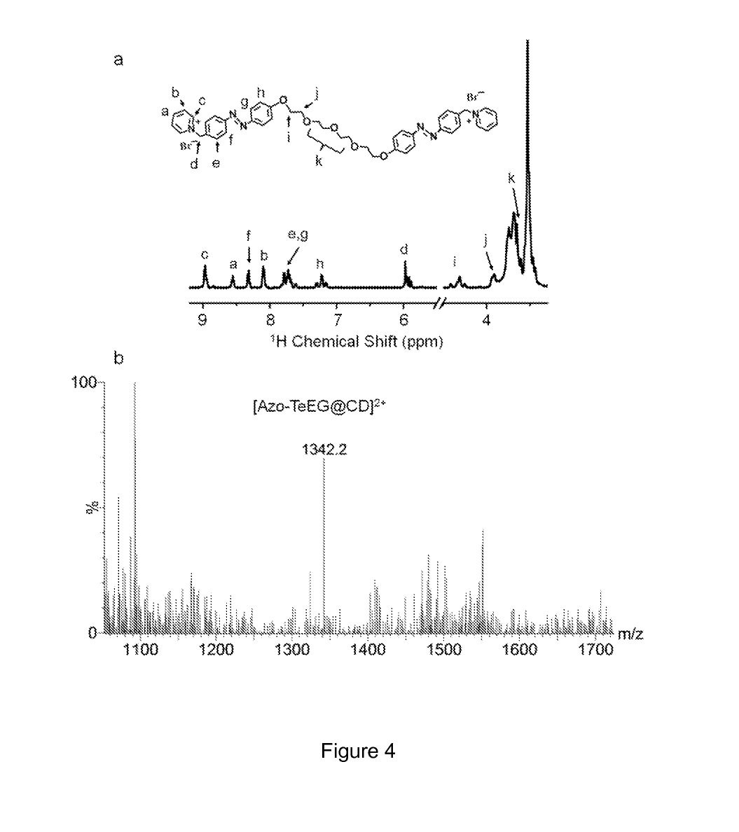

In order to block the possible aggregation and control the space adaptation of the cationic groups, two CDs were used to recognize the two Azo groups in one bolaform cationic molecule (Azo-Tr/TeEG.2Br) (see Examples), and the obtained cationic pseudorotaxanes were characterized by ¹H-NMR and ESI-MS/MS spectra (FIGS. 3 and 4), indicating successful synthesis of Azo-TrEG@CD.2Br or Azo-TeEG@CD.2Br.

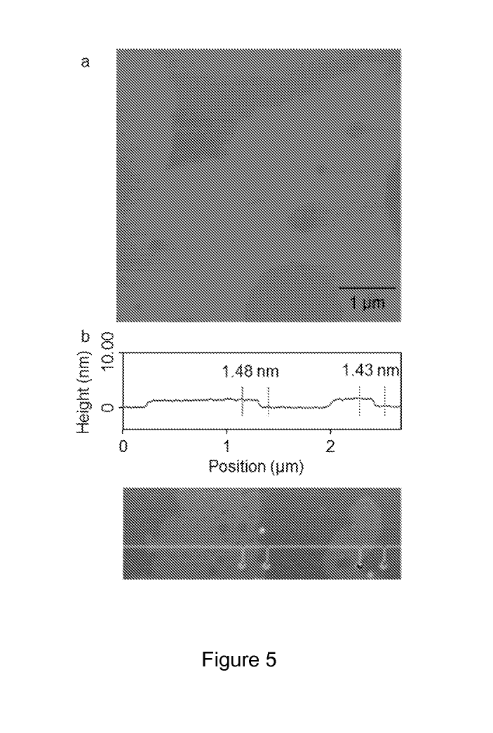

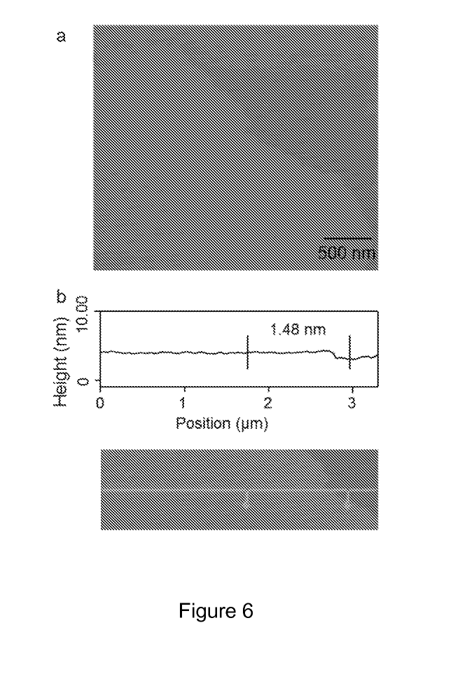

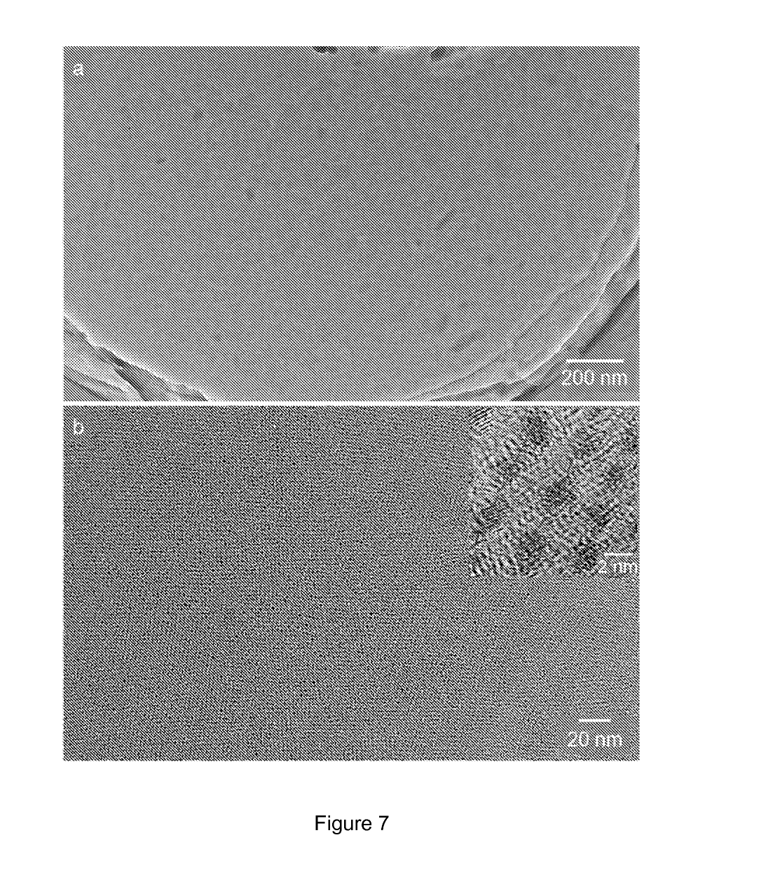

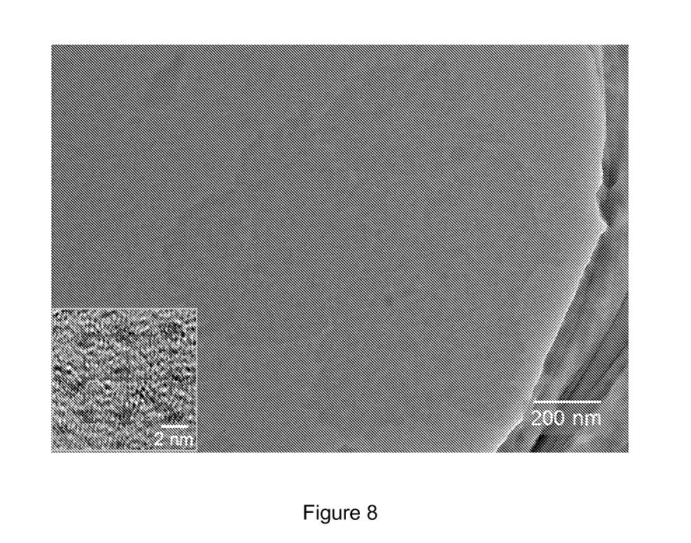

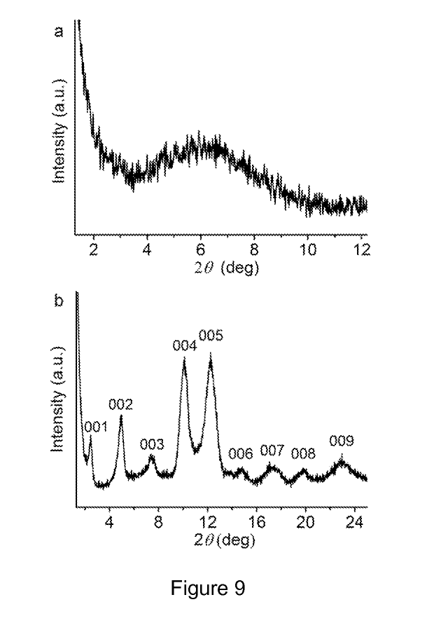

Upon the addition of polyanion POM into the cationic pseudorotaxane solution, the cationic heads of the bridging sticks can be tethered together by the polyanionic POM connecting node via ionic bond, yielding a supramolecular polymer (see Examples). The obtained supramolecular polymers were characterized by using microscopic technics. AFM images demonstrate that the supramolecular polymers appear as very thin micrometer-scale sheets with an average height from 1.43 to 1.48 nm (FIGS. 5 and 6), in perfect agreement with the interlayer spacing of 1.49 nm measured by powder XRD pattern of the freeze-dried supramolecular polymer sample (FIG. 9a). Considering the accord of this value with the diameter (1.46 nm) of a CD ring, 2D single-layer supramolecular polymers can be rationally inferred. And HRTEM images further demonstrate the micrometer-scale sheets of the 2D single-layer supramolecular polymers (FIGS. 7 and 8). Due to the electron density contrast between organic and inorganic components, the inorganic clusters can be well discerned as dark spots with long-range uniform orthogonal mesh-like structure with edge length around 3.7 nm in the single-layer sheet. This fantastic orthogonal framework structure was further identified by XRD pattern measurement (FIG. 9b). The diffraction pattern of the sample film prepared by the filtration of the supramolecular polymer [Azo-TrEG@CD]₂[PWV] exhibits nine diffraction peaks, which can be perfectly indexed into an in-layer lamellar structure with 3.7 nm of spacing, in perfect accord with the HRTEM results. This value is also in good agreement with the calculated ideal length of the orthogonal framework of [Azo-TrEG@CD]₂[PWV] (from 3.8 to 4.6 nm) after considering the utmost shrinkage and stretching.

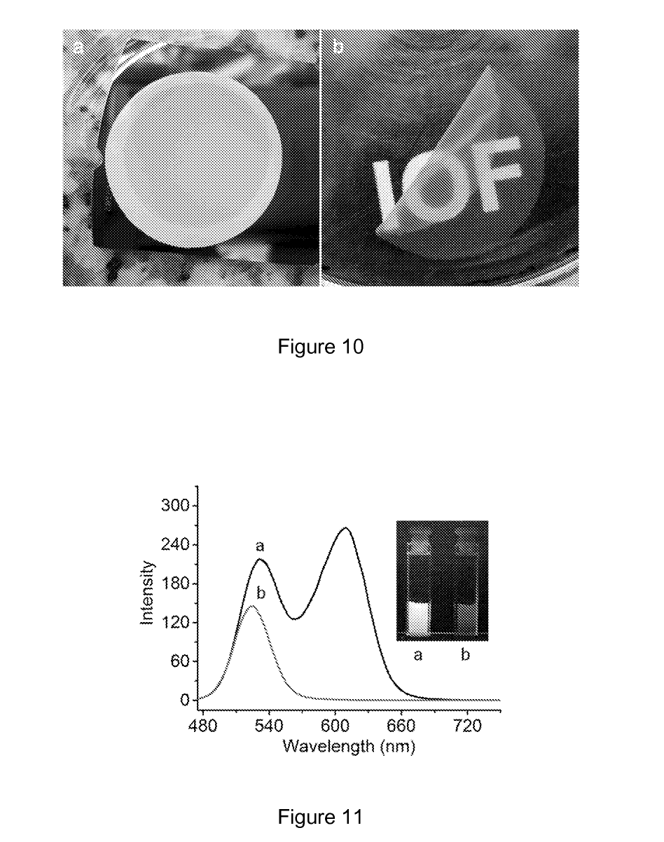

When filtering the obtained 2D single-layer supramolecular polymers (either [Azo-TrEG@CD]₂[PWV] or [Azo-TeEG@CD]₂[PWV]) on a supporting polycarbonate filter, a Tr-membrane or Te-membrane can be obtained, respectively (see Examples), and they display good flexibility and mechanical stability. For example, after drying in the oven at 40° C. for 48 h and the dissolution of the polycarbonate filter in chloroform, an intact free-standing transparent Tr-membrane based on supramolecular polymer was obtained (FIG. 10).

The pore aperture of the supramolecular polymer membranes can be modulated by the number of the EG groups. For Tr-/Te-menbrane, considering the torsion-induced shrinking of the EG groups, its mesh size is estimated to be in the region from 2.4 to 3.4 nm or from 2.4 to 4.1 nm.

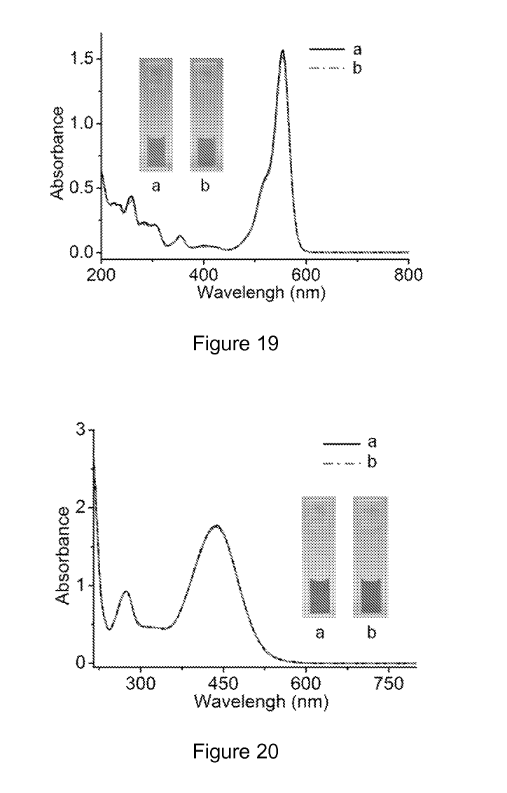

The regular porosity and flexibility, especially the convenience in preparation of the supramolecular polymer membrane provide applicable applications in precise nano-size separation. To demonstrate the capacity of the supramolecular polymer membrane in size-selective separation, As an initial attempt, three kinds of small molecules, rhodamine B, xylenol orange (pH=4.0 and 7.9) and the mixture of α-, β-, and γ-CDs, which are positive and negative charged, and nonionic at different pH conditions while maintaining the size less than 2 nm, were chosen as the filtered chemical objects through Tr-membrane (see Examples). The filtrates of rhodamine B and xylenol orange were detected by ultraviolet-visible spectra (FIG. 19-21), and matrix-assisted laser desorption ionization-time of flight mass spectra for that of CD mixture (FIG. 22). All three kinds of small molecules, regardless of positive charge, negative charge, or non-charge, can pass through the membrane without obvious quantity loss, indicating a fluently passing ability for organic molecules smaller than 2 nm in diameter.

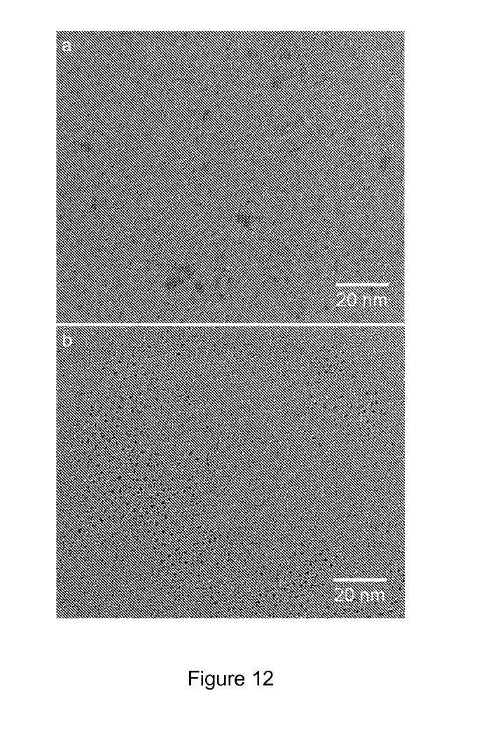

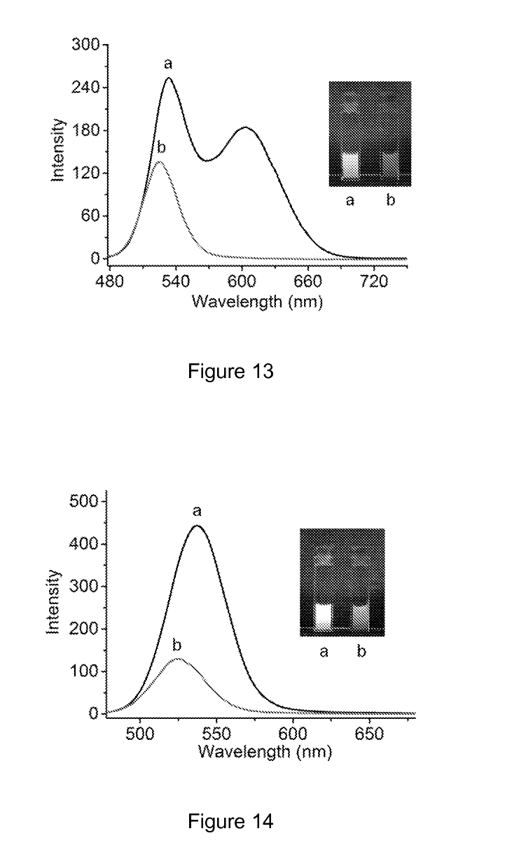

As for the separation of the QDs, typically, the QDs mixture solution (1) of two differently sized CdTe QDs are modified with 1-thioglycerol, in which the smaller one having an average particle size D=3.3 nm in diameter with green emission (λₘₐₓ=533 nm) and the bigger one having an average size D=4.4 nm in diameter with red emission (λₘₐₓ=611 nm) after considering the thickness of modified surface layer, was chosen as model nanomaterials for size separation (see Examples). The filtrate was monitored by emission spectrum (FIG. 11) and high resolution transmission electron microscopy (FIG. 12). After filtration by using Tr-membrane, the photographs show the orange luminescence turns green; furthermore, a 10-nm blue-shifting(λₘₐₓ=523 nm) of the emission band occurs in the filtrate with a separation efficiency of 73.4%; meanwhile, the HRTEM images demonstrate the size of QDs in the filtrate become smaller; indicative of which only the QDs with small size have passed through the Tr-membrane, while the larger size part were blocked by the membrane. Similar separation experiments of differently sized QDs were conducted by using the Tr-membrane or Te-membrane (FIGS. 13-18 and 23-26, see Examples).

### EXAMPLES

General Experiments (bridging sticks): N-bromosuccinimide (NBS), benzoyl peroxide (BPO) and α-cyclodextrin (CD) were obtained from TCI Chemicals (China) Pvt. Ltd. Triethylene glycol di(p-toluenesulfonate), etraethylene glycol di(p-toluenesulfonate), D₂O and DMSO-d₆ were purchased from Aldrich and used without purification. Water is double-distilled (Milli-Pore 18.2 MΩcm⁻¹). Phenol, acetonitrile (MeCN), carbon tetrachloride (CCl₄), dimethylformamide (DMF), pyridine and ethyl acetate were obtained from Beijing Chemical Reagent Industry and used as received, unless indicated otherwise. MeCN was dried over P₂O₅ and distilled prior to use. DMF was dried with CaH₂ for 7 days and distilled before using. All other reagents and solvents were purchased from commercial sources and without purification. ¹H-NMR spectra were recorded on a Bruker AVANCE 500 MHz spectrometer while the chemical shifts were corrected by the solvent value (λ=4.79 ppm for D₂O and λ=2.50 ppm for DMSO-d₆). The ESI-MS/MS spectra were carried out by POEMS inductively coupled plasma mass spectrometer (TJA, USA).

### Synthesis of Bolaform Cationic Molecules

The synthesis scheme of bolaform cationic molecules is presented in Scheme 1:

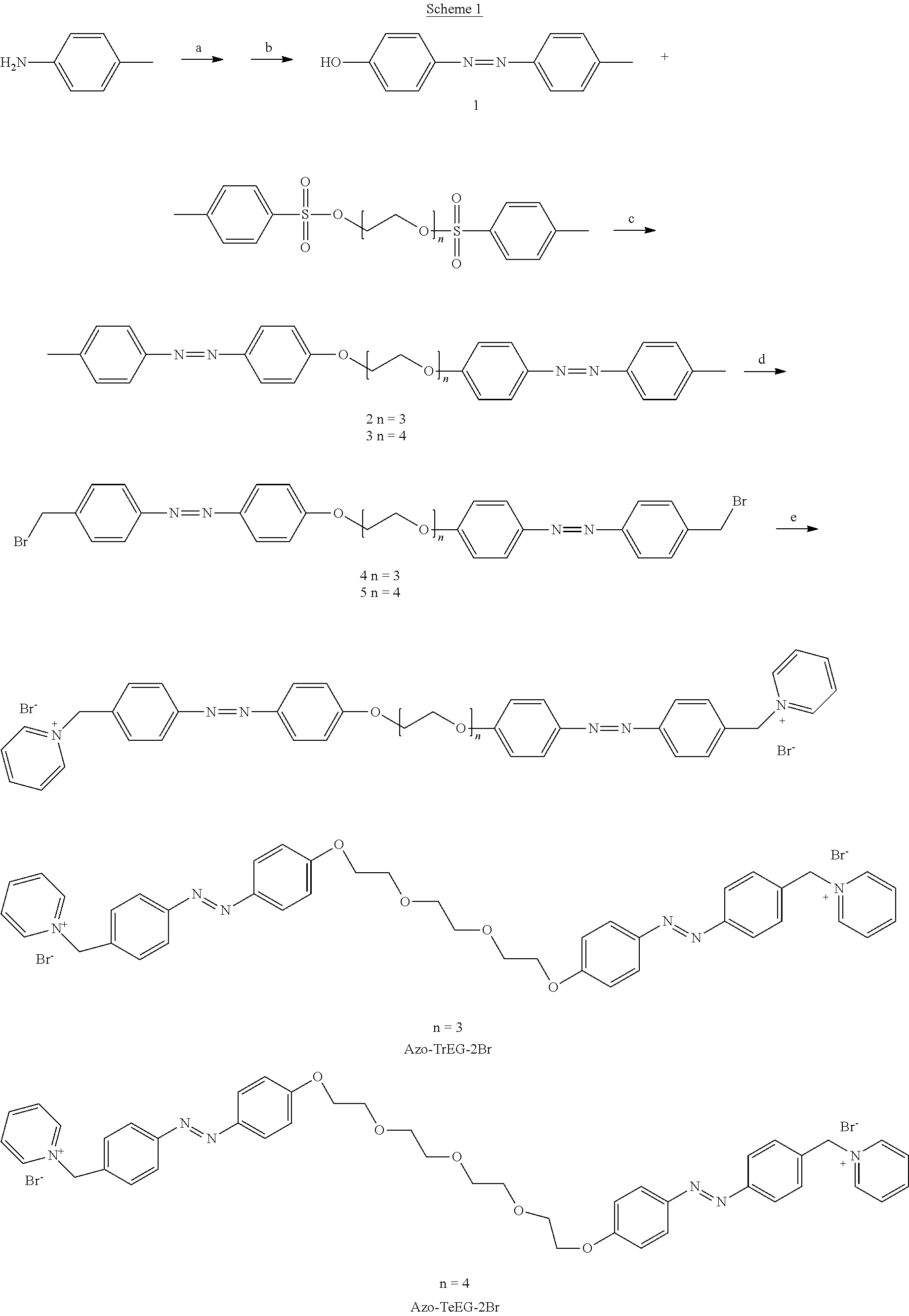

Scheme 1, reagents and conditions: a) NaNO₂, HCl, H₂O, 0° C.; b) phenol, NaOH, Na₂CO₃, H₂O, 0° C.; c) K₂CO₃, anhydrous MeCN, 80° C.; d) NBS, BPO, CCl₄, 70° C.; e) pyridine, DMF, 100° C.

Synthesis of Compound (1): 4-toluidine (1.38 g, 12.9 mmol) was dissolved in HCl aqueous solution (8 mL 1.6 M) and mixed with aqueous solution (20 mL) of NaNO₂ (1.04 g, 15.1 mmol), and then cooled to 0° C. Phenol (1.41 g, 15.0 mmol), NaOH (1.04 g, 26.0 mmol) and Na₂CO₃ (2.75 g, 25.9 mmol) were dissolved in water (60 mL) and added dropwise into the above solution. After stirring for 3 h at 0° C., the precipitate was collected, washed by water for 3 times, and recrystallized from acetone to yield Compound 1 (1.92 g, 9.1 mmol, 70%).

Synthesis of Compound (2): Compound 1 (2.00 g, 9.4 mmol), K₂CO₃ (1.30 g, 9.4 mmol) and triethylene glycol di(p-toluenesulfonate) (1.90 g, 4.1 mmol) were added in anhydrous MeCN (20 mL), and then refluxed for 24 h. The mixture was filtrated to remove K₂CO₃ and then recrystallized in MeCN to give Compound 2 (1.79 g, 3.4 mmol, 83%).

Synthesis of Compound (3): Compound 1 (2.00 g, 9.4 mmol), K₂CO₃ (1.30 g, 9.4 mmol) and tetraethylene glycol di(p-toluenesulfonate) (1.90 g, 3.8 mmol) were added in anhydrous MeCN (20 mL), and then refluxed for 24 h. The mixture was filtrated to remove K₂CO₃ and then recrystallized in MeCN to yield Compound 3 (1.92 g, 3.3 mmol, 87%).

Synthesis of Compound (4): Compound 2 (1.00 g, 1.9 mmol), NBS (0.70 g, 3.9 mmol) and BPO (48.45 mg, 0.2 mmol) were added in CCl₄ (40 mL), and then warmed to 70° C. and stirred for 7 h. The reaction mixture was filtrated to remove the insoluble substance and then recrystallized in CCl₄ to give Compound 4 (0.62 g, 0.9 mmol, 47%).

Synthesis of Compound (5): Compound 3 (1.00 g, 1.7 mmol), NBS (0.70 g, 3.9 mmol) and BPO (48.5 mg, 0.2 mmol) were added in CCl₄ (40 mL), and then warmed to 70° C. and stirred for 7 h. The reaction mixture was filtrated to remove the insoluble substance and then recrystallized in CCl₄ to yield Compound 5 (0.74 g, 1.0 mmol, 59%).

Synthesis of Azo-TrEG.2Br: Compound 4 (1.00 g, 1.44 mmol), pyridine (2 mL, 24.8 mmol) were dissoved in DMF (5 mL), and then warmed to 100° C. and stirred for 48 h. The reaction solution was cooled to RT and added dropwise to ethyl acetate (500 mL), and the yielding precipitate was collected and washed with ethyl acetate (1000 mL) for three times to give the product Azo-TrEG.2Br (0.93 g, 1.09 mmol, 76%). ¹H-NMR (500 MHz, D₂O, 25° C.) (FIG. 1a): λ=8.87 (d, 4H, Ar—H), 8.57 (t, 2H, Ar—H), 8.07 (t, 4H, Ar—H), 7.62 (d, 4H, Ar—H), 7.57 (d, 4H, Ar—H), 7.51 (d, 4H, Ar—H), 6.92 (d, 4H, Ar—H), 5.75 (s, 4H, CH₂), 4.10 (t, 4H, CH₂), 3.86 (t, 4H, CH₂), 3.77 (s, 4H, CH₂) ppm. ESI-MS (FIG. 1b) calculated for Azo-TrEG.2Br (C₄₂H₄₂N₆O₄.2Br): m/z=347.4 ([Azo-TrEG]²). Found: m/z=347.4.

Synthesis ofAzo-TeEG.2Br: Compound 5 (1.00 g, 1.35 mmol), pyridine (2 mL, 24.8 mmol) were dissoved in DMF (5 mL), and then warmed to 100° C. and stirred for 48 h. The reaction solution was cooled to RT and added dropwise to ethyl acetate (500 mL), and the yielding precipitate was collected and washed with ethyl acetate (1000 mL) for three times to give the product Azo-TeEG.2Br (0.90 g, 1.00 mmol, 74%). ¹H-NMR (500 MHz, DMSO-d₆, 25° C.) (FIG. 2a): μ=9.26 (d, 4H, Ar—H), 8.67 (t, 2H, Ar—H), 8.22 (t, 4H, Ar—H), 7.98-7.80 (m, 8H, Ar—H), 7.72 (d, 4H, Ar—H), 7.17 (d, 4H, Ar—H), 5.97 (s, 4H, CH₂), 4.21 (t, 4H, CH₂), 3.79 (t, 4H, CH₂), 3.65-3.50 (m, 8H, CH₂) ppm. ESI-MS (FIG. 2b) calculated for Azo-TeEG.2Br (C₄₄H₄₆N₆O₅.2Br): m/z=369.2 ([Azo-TeEG]²⁺). Found: m/z=369.6.

Synthesis of Cationic Pseudorotaxanes

Synthesis ofAzo-TrEG@CD.2Br: Azo-TrEG.2Br (4.5 mg, 5.3 μmol) and CD (10.2 mg, 10.5 μmol) were dissolved in water (60 mL) under sonication for 0.5 h to generate the cationic pseudorotaxane Azo-TrEG@CD.2Br with the concentration of 88.3 μM. That two Azo groups in one Azo-TrEG.2Br were recognized by two CDs to form the cationic pseudorotaxane Azo-TrEG@CD.2Br was confirmed by ¹H-NMR (FIG. 3a) and ESI-MS (FIG. 3b) results. ESI-MS (FIG. 3b) calculated for Azo-TrEG@CD.2Br [(C₄₂H₄₂N₆O₄)(C₃₆H₆₀O₃₀)₂.2Br]: m/z=1320.2 ([Azo-TrEG@CD]²⁺). Found: m/z=1319.8.

Synthesis ofAzo-TeEG@CD.2Br: Azo-TeEG.2Br (4.5 mg, 5.0 μmol) and CD (9.8 mg, 10.1 μmol) were dissolved in water (60 mL) under sonication for 0.5 h to generate the cationic pseudorotaxane Azo-TeEG@CD.2Br with the concentration of 83.3 λM. That two Azo groups in one Azo-TeEG.2Br were recognized by two CDs to form the cationic pseudorotaxane Azo-TeEG@CD.2Br was confirmed by ¹H-NMR (FIG. 4a) and ESI-MS (FIG. 4b) results. ESI-MS (FIG. 4b) calculated for Azo-TeEG@CD.2Br [(C₄₄H₄₆N₆O₅)(C₃₆H₆ₒ0₃₀)₂.2Br]: m/z=1342.2 ([Azo-TeEG@CD]²⁺′). Found: m/z=1342.2.

### Synthesis of 2D Single-Layer Supramolecular Polymers

General Synthetic Conditions: The polyanion cluster K₄[PW₁₁VO₄₀] and H₄[PMo₁₁VO₄₀] were prepared following the published procedures. Water is double-distilled (Milli-Pore 18.2 MΩcm⁻¹). Inductively coupled plasma atomic emission spectrometry (ICP-AES) was carried out on the PerkinElmer Optima 3300DV (PerkinElmer, USA). Organic element analysis (EA) was carried out on the vario MACRO cube CHNS (Elementar, Germany).

Synthesis of [Azo-TrEG@CD] [PWV]: K₄PW₁₁VO₄₀ (7.6 mg, 2.6 μmol) was dissolved in 60 mL water and mixed with the as-prepared Azo-TrEG@CD.2Br solution (60 mL, 88.3 μM). After aging for 5 min, the 2D single-layer supramolecular polymers [Azo-TrEG@CD] [PWV] with the concentration of 0.17 mg mL⁻¹. The 2D single-layer supramolecular polymer with long-range uniform orthogonal mesh-like structure was confirmed by AFM (FIG. 5), HRTEM (FIG. 7) and XRD (FIG. 9) results. EA and ICP-AES results: Anal. Calc. for [Azo-TrEG@CD] [PWV] {[(C₄₂H₄₂N₆O₄)(C₃₆H₆₀O₃₀)₂]₂[PW₁₁VO₄₀](H₂O)₂}ⁿ: C, 33.97; H, 4.10; N, 2.09; P, 0.38; W, 25.08; V, 0.63. Found: C, 34.06; H, 4.10; N, 2.12; P, 0.36; W, 24.72; V, 0.68.

Synthesis of [Azo-TrEG@CD] [PMoV]: H₄PMo₁₁VO₄₀ (4.6 mg, 2.6 μmol) was dissolved in 60 mL water and mixed with the as-prepared Azo-TrEG@CD.2Br solution (60 mL, 88.3 μM). After aging for 5 min, the 2D single-layer supramolecular polymers [Azo-TrEG@CD] [PWV] {[(C₄₂H₄₂N₆O₄)(C₃₆H₆₀O₃₀)₂]₂[PMo₁₁VO₄₀]}ₙ with the concentration of 0.15 mg mL¹.

Synthesis of [Azo-TeEG@CD][PWV]: K₄PW₁₁VO₄₀ (7.3 mg, 2.5 μmol) was dissolved in 60 mL water and mixed with the as-prepared Azo-TeEG@CD.2Br solution (60 mL, 83.3 μM). After aging for 5 min, the 2D single-layer supramolecular polymers [Azo-TeEG@CD] [PWV] with the concentration of 0.17 mg mL⁻¹. The 2D single-layer supramolecular polymer with long-range uniform orthogonal mesh-like structure was confirmed by AFM (FIG. 6) and HRTEM (FIG. 8) results. EA and ICP-AES results: Anal. Calc. for [Azo-TeEG@CD] [PWV] {[(C₄₄H₄₆N₆O₅)(C₃₆H₆₀O₃₀)₂]₂[PW₁₁VO₄₀](H₂O)₄}ₙ: C, 34.04; H, 4.19; N, 2.05; P, 0.38; W, 24.70; V, 0.62. Found: C, 34.32; H, 4.26; N, 2.04; P, 0.42; W, 24.52; V, 0.64.

### Atomic Force Microscopy Imaging (AFM)

General: Samples of the synthesized supramolecular polymers for AFM measurements were prepared by a dip-coating technique. First, we dipped a mica wafer quickly into the as-prepared supramolecular polymers solution with the concentration of 0.02 mg mL⁻¹, and then slowly withdrew at a constant speed of 1 mm min⁻¹. During the process, the supramolecular polymers would attach on the surface of the mica. AFM images were taken with a SPA-300HV (Seiko, Japan) under ambient conditions. AFM was operated in the tapping mode with an optical readout using Si cantilevers. Two samples of the synthesized supramolecular polymers were surveyed, and 2D single-layer supramolecular polymer sheets can be observed in the surveyed samples. AFM images of the supramolecular polymers were presented in the FIGS. 5 and 6: AFM images of [Azo-TrG@CD] [PWV] (FIG. 5); [Azo-TeG@CD] [PWV] (FIG. 6).

### High Resolution Transmission Electron Microscopy Imaging (HRTEM)

General: Samples of the synthesized 2D single-layer supramolecular polymers for HRTEM measurements were prepared by using a thin copper ring to spread a thin layer of 2D single-layer supramolecular polymer solution (0.02 mg mL⁻¹) and casting it on a copper grid, then repeating the above process three times for one sample. HRTEM was conducted on a JEOL JEM 2010 electron microscope under an accelerating voltage of 200 kV without staining During the measurement, longer exposure time to the high-energy electron beam would destroy the framework structure, resulting in less ordered structures. Thus the HRTEM images were tracked within a quite short irradiation time. Moreover, in order to obtain a clear high contrast image, we used a smart camera technique for image collection, which was based on continuous acquisition of images to get high image contrast. Due to the heating disturbance of the sample during the electron beam irradiation, the image superposition brought slight ghosting phenomenon, which causes the size of inorganic clusters seemed larger than their ideal dimension. Two samples of the synthesized 2D single-layer supramolecular polymers were surveyed, and long-range uniform orthogonal mesh-like structure in the sheets can be observed in the surveyed samples. HRTEM images of the 2D single-layer supramolecular polymers were presented in the FIGS. 7 and 8: AFM images of [Azo-TrG@CD] [PWV] (FIG. 7); [Azo-TeG@CD] [PWV] (FIG. 8).

### X-Ray Diffraction Studies (XRD)

General: Two kinds of samples of the synthesized 2D single-layer supramolecular polymers were prepared for XRD measurements. One is the powdered samples prepared by the lyophilization of the 2D single-layer supramolecular polymer solution (0.18 mg mL⁻, 120 mL) and then grinding it into powder. The other is the film samples prepared by the filtration of 2D single-layer supramolecular polymer solution (0.18 mg mL⁻¹, 120 mL) over a supporting filter (Whatman Nuclepore Track-Etched Polycarbonate Membrane; effective filtration area: 3.14 cm²; pore size: 200 nm) and drying in oven at 40° C. for 48 h. XRD data were recorded on a Rigaku SmartLab X-ray diffractometer using Cu Kα₁ radiation at wavelength of 1.542 Å. Two samples of the synthesized 2D single-layer supramolecular polymers were surveyed and lamellar structure or in-layer lamellar structure can be observed in the surveyed samples. XRD patterns of [Azo-TrG@CD] [PWV] were presented in the FIG. 9: XRD patterns of powdered sample (FIG. 9a, lamellar structure); film sample (FIG. 9b, in-layer lamellar structure).

### Preparation of Supramolecular Polymer Membranes

General Experiment: The polycarbonate filters with 0.2 μm pore-size were the product of Whatman Filters (a GE Healthcare brand).

Preparation of Tr-membrane: The [Azo-TrEG@CD] [PWV] aqueous solution (20 mL, 0.04 mg mL⁻¹) was filtered over a supporting polycarbonate filter at a constant filtration rate of 4 mL min⁻¹ and then washed with 10 mL water to give the Tr-membrane. The flexibility and good mechanical stability of the supramolecular polymer membrane were confirmed by the photographs before and after the dissolution of the supporting polycarbonate filter in CHCl₃, as shown in FIG. 10.

Preparation of Te-membrane: The [Azo-TeEG@CD] [PWV] aqueous solution (20 mL, 0.04 mg mL⁻¹) was filtered over a supporting polycarbonate filter at a constant filtration rate of 4 mL min⁻¹ and then washed with 10 mL water to give the Te-membrane.

### Nano-Size Separation Studies

General Methods: α-, μ-, γ-CD, rhodamine B and xylenol orange are the products of TCI Chemicals (China) Pvt. Ltd. The CdTe QDs were prepared and characterized following the published procedures. Water is double-distilled (Milli-Pore 18.2 MΩcm^{—1}). The polycarbonate membranes with 0.2μm pore-size are the product of Whatman Filters (a GE Healthcare brand). UV-Vis spectra were carried out on a spectrometer (Varian CARY 50 Probe). HRTEM was conducted on a JEOL JEM 2010 electron microscope under an accelerating voltage of 200 kV without staining MALDI-TOF mass spectrum was recorded on an autoflex MALDI-TOF/TOF (Bruker, Germany) mass spectrometer equipped with a nitrogen laser (337 nm, 3 ns pulse). The fluorescence spectra were carried out using the spectrophotometer (Shimadzu RF-5301PC). The core diameter (D_{c}) of CdTe QDs was calculated according to the following published equation: D_{c}=(9.8127×10⁻⁷)λₘₐₓ³−(1.7147×10 ⁻³)λₘₐₓ²+(1.0064)λₘₐₓ−194.84, where λₘₐₓ(nm) is the maximum wavelength corresponding to the first excitonic absorption peak of QDs. The full diameter of surface stabilized CdTe QDs (average diameter D) was calculated by summing the length of ligands (l) and the calculated D_{c} value, where the length of ligand stabilizer is estimated in ca. 0.46 nm for 1-thioglycerol and ca. 0.65 nm for 3-mercaptopropionic acid, simulated by ChemBio 3D (12.0 version). The separation efficiency of QDs is carried out by evaluating relative fluorescence intensity of filtrates before and after filtering at the maximum emission wavelength.

Separation of QDs mixture solution (1) by Tr-membrane: 1-Thioglycerol decorated CdTe QDs (0.1 mL, 10 mM, λₘₐₓ=533 nm with green emission, D=3.3 nm) and 1-thioglycerol decorated CdTe QDs (0.4 mL, 5 mM, λₘₐₓ=611 nm with red emission, D=4.4 nm) were added into water (19.5 mL) to obtain QDs mixture solution (1). The mixture solution was filtered by the as-prepared Tr-membrane and fluorescence spectrum was used to detect the fluorescence change of QDs mixture solution (1) before and after filtering through Tr-membrane (FIG. 11). After filtration, the photographs show the orange luminescence turns green; furthermore, a 10-nm blue-shifting (λₘₐₓ=523 nm, D=3.0 nm) of the emission band occurs in the filtrate with a separation efficiency of 73.4%; meanwhile, the HRTEM images (FIG. 12) demonstrate the size of QDs in the filtrate becomes smaller, indicative of which only the QDs with small size have passed through the Tr-membrane, while the large size part were blocked by the membrane.

Separation of QDs mixture solution (2) by Tr-membrane: 1-Thioglycerol decorated CdTe QDs (0.1 mL, 10 mM, λₘₐₓ=533 nm with green emission, D=3.3 nm) and 3-mercaptopropionic acid decorated CdTe QDs (0.0125 mL, 10 mM, λₘₐₓ=606 nm with red emission, D=4.8 nm) were added into water (19.9 mL) to obtain QDs mixture solution (2). The mixture solution was filtered by the as-prepared Tr-membrane and fluorescence spectrum was used to detect the fluorescence change of QDs mixture solution (2) before and after filtering through Tr-membrane (FIG. 13). After filtration, the photographs show the orange luminescence turns green; furthermore, a 9-nm blue-shifting (λₘₐₓ=524 nm, D=3.0 nm) of the emission band occurs in the filtrate with a separation efficiency of 68.8%, indicative of which only the QDs with small size have passed through the Tr-membrane, while the large size part were blocked by the membrane.

Separation of QDs mixture solution (3) by Tr-membrane: 1-Thioglycerol decorated CdTe QDs (0.1 mL, 10 mM, λₘₐₓ=533 nm with green emission, D=3.3 nm) and 3-mercaptopropionic acid decorated CdTe QDs (0.025 mL, 10 mM, λₘₐₓ=545 nm with green emission, D=4.0 nm) were added into water (19.9 mL) to obtain QDs mixture solution (3). The mixture solution was filtered by the as-prepared Tr-membrane and fluorescence spectrum was used to detect the fluorescence change of QDs mixture solution (3) before and after filtering through Tr-membrane (FIG. 14). After filtration, the photographs show the green luminescence turns light green; furthermore, a 10-nm blue-shifting (λₘₐₓ=523 nm, D=3.0 nm) of the emission band occurs in the filtrate, indicative of which only the QDs with small size have passed through the Tr-membrane, while the large size part were blocked by the membrane. And the separation efficiency of the QDs mixture solution (3) by using Tr-membrane cannot be evaluated accurately from the analysis of relative fluorescence intensity before and after filtering at 523 nm, due to the emission of 3-mercaptopropionic acid decorated CdTe QDs locating at the same wavelength.

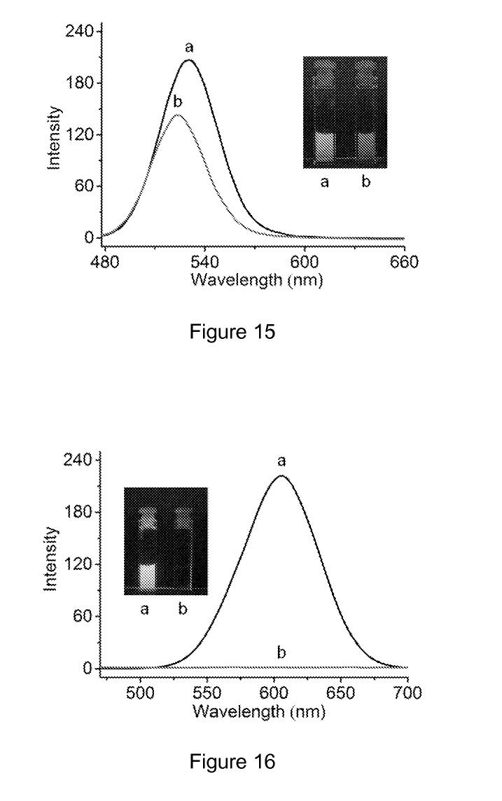

Separation of QDs solution (4) by Tr-membrane: 1-Thioglycerol decorated CdTe QDs (0.1 mL, 10 mM, 2ₘₐₓ=533 nm with green emission, D=3.3 nm) was added into water (19.9 mL) to obtain QDs solution (4). The solution was filtered by the as-prepared Tr-membrane and fluorescence spectrum was used to detect the fluorescence change of QDs solution (4) before and after filtering through Tr-membrane (FIG. 15). After filtration, the photographs show the green luminescence turns light-green; furthermore, a 10-nm blue-shifting (λₘₐₓ=523 nm, D=3.0 nm) of the emission band occurs in the filtrate with a separation efficiency of 76.3%, indicative of which only the QDs with small size have passed through the Tr-membrane, while the large size part were blocked by the membrane.

Separation of QDs solution (5) by Tr-membrane: 3-Mercaptopropionic acid decorated CdTe QDs (0.0125 mL, 10 mM, λₘₐₓ=606 nm with red emission, D=4.8 nm) was added into water (20 mL) to obtain QDs solution (5). The solution was filtered by the as-prepared Tr-membrane and fluorescence spectrum was used to detect the fluorescence change of QDs solution (5) before and after filtering through Tr-membrane (FIG. 16). After filtration, the photographs show the red luminescence turns colorless; furthermore, no fluorescence can be observed in the filtrate, indicating that the QDs cannot pass through the Tr-membrane.

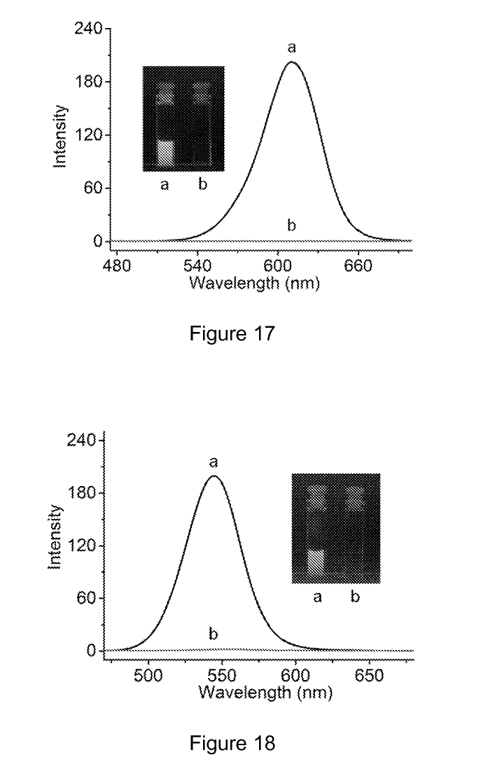

Separation of QDs solution (6) by Tr-membrane: 1-Thioglycerol decorated CdTe QDs (0.4 mL, 5 mM, λₘₐₓ=611 nm with red emission, D=4.4 nm) was added into water (19.6 mL) to obtain QDs solution (6). The solution was filtered by the as-prepared Tr-membrane and fluorescence spectrum was used to detect the fluorescence change of QDs solution (6) before and after filtering through Tr-membrane (FIG. 17). After filtration, the photographs show the red luminescence turns colorless; furthermore, no fluorescence can be observed in the filtrate, indicating that the QDs cannot pass through the Tr-membrane.

Separation of QDs solution (7) by Tr-membrane: 3-Mercaptopropionic acid decorated CdTe QDs (0.05 mL, 10 mM, λₘₐₓ=545 nm with green emission, D=4.0 nm) was added into water (19.95 mL) to obtain QDs solution (7). The solution was filtered by the as-prepared Tr-membrane and fluorescence spectrum was used to detect the fluorescence change of QDs solution (7) before and after filtering through Tr-membrane (FIG. 18). After filtration, the photographs show the green luminescence turns colorless; furthermore, no fluorescence can be observed in the filtrate, indicating that the QDs cannot pass through the Tr-membrane.

Separation of rhodamine B solution by Tr-membrane: Rhodamine B (4 mg, 0.42 mM, molecular size: ˜1.6 nm) was dissolved into water (20 mL) to obtain the rhodamine B solution. The solution was filtered by the as-prepared Tr-membrane and UV-vis spectrum was used to detect the absorbance change of the rhodamine B solution before and after filtering through Tr-membrane (FIG. 19). After filtration, the photograph and UV-vis spectrum of the filtrate show no obvious change, indicating that rhodamine B with positive charge can pass through the Tr-membrane. This embodiment demonstrates small molecules with positive charge can pass through the membrane without obvious quantity loss.

Separation of xylenol orange solution (pH=3.8) by Tr-membrane: Xylenol orange (7.3 mg, 0.48 mM, molecular size: ˜1.9 nm) was dissolved into water (20 mL) to obtain the xylenol orange solution (pH=3.8). The solution was filtered by the as-prepared Tr-membrane and UV-vis spectrum was used to detect the absorbance change of the xylenol orange solution before and after filtering through Tr-membrane (FIG. 20). After filtration, the photograph and UV-vis spectrum of the filtrate show no obvious change, indicating that xylenol orange bearing carboxylic acid can pass through the Tr-membrane.

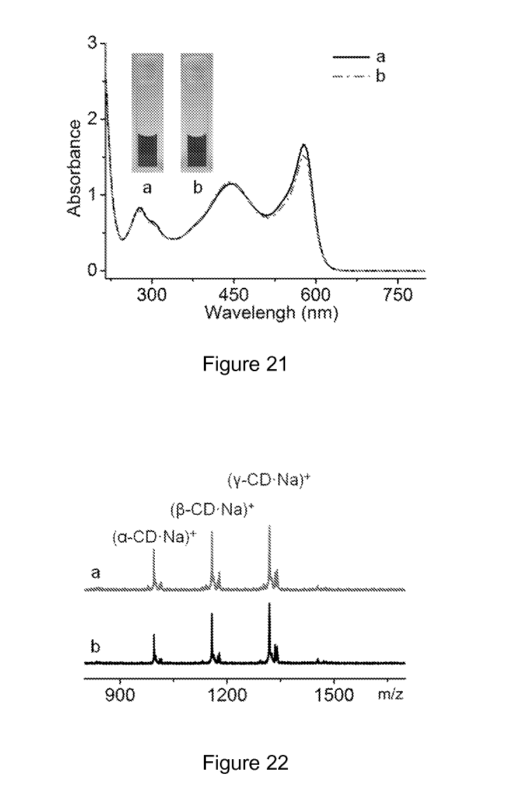

Separation of xylenol orange solution (pH=7.9) by Tr-membrane: Xylenol orange (7.3 mg, 0.48 mM, molecular size: 1.9 nm) was dissolved into water (20 mL) and its pH value was adjusted from 3.8 to 7.9 by using NaOH aqueous solution (0.1 M), yielding the xylenol orange solution (pH=7.9). The solution was filtered by the as-prepared Tr-membrane and UV-vis spectrum was used to detect the absorbance change of the xylenol orange solution before and after filtering through Tr-membrane (FIG. 21). After filtration, the photograph and UV-vis spectrum of the filtrate show no obvious change, indicating that xylenol orange bearing carboxylic anion can pass through the Tr-membrane. These two embodiments about xylenol orange demonstrate small molecules with negative charge can pass through the membrane without obvious quantity loss.

Separation of cyclodextrin mixture solution by Tr-membrane: α-CD (5 mg, 5.1 mM, molecular size: ˜1.46 nm), μ-CD (5.8 mg, 5.1 mM, molecular size: ˜1.66 nm) and γ-CD (6.7 mg, 5.1 mM, molecular size: ˜1.77 nm) were dissolved into water (20 mL) to obtain the cyclodextrin mixture solution. The mixture solution was filtered by the as-prepared Tr-membrane and MALDI-TOF mass spectrum was used to detect the change of the cyclodextrin mixture solution before and after filtering through Tr-membrane (FIG. 22). After filtration, the MALDI-TOF mass spectrum of the filtrate shows no obvious change in the relative intensity which relates to the relative concentration, indicating that cyclodextrins with non-charge can pass through the Tr-membrane. This embodiment demonstrates small molecules with non-charge can pass through the membrane without obvious quantity loss.

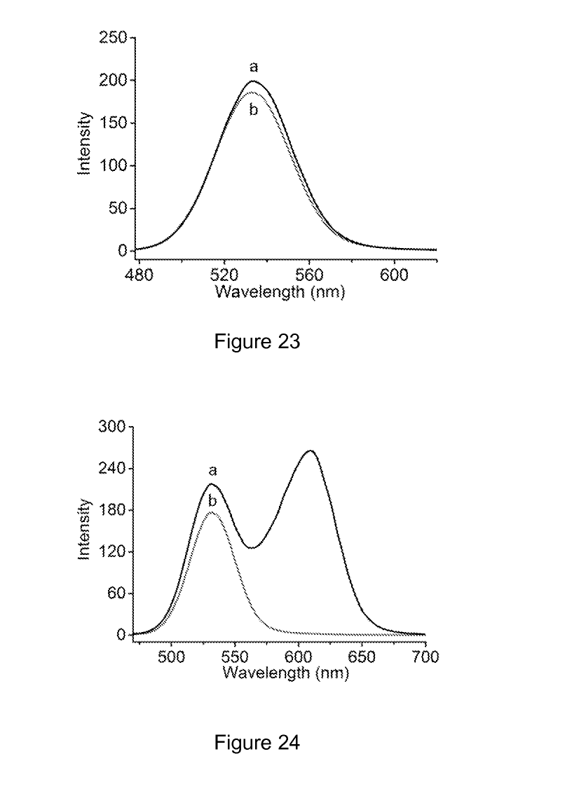

Separation of QDs solution (4) by Te-membrane: 1-Thioglycerol decorated CdTe QDs (0.1 mL, 10 mM, 803 ₘₐₓ=533 nm with green emission, D=3.3 nm) was added into water (19.9 mL) to obtain QDs solution (4). The solution was filtered by the as-prepared Te-membrane and fluorescence spectrum was used to detect the fluorescence change of QDs solution (4) before and after filtering through Te-membrane (FIG. 23). After filtration, the fluorescence spectrum of the filtrate shows no obvious change in the emission band (λₘₐₓ=533 nm, D=3.3 nm) with a separation efficiency of 93.4%, indicating almost all the QDs have passed through the Te-membrane. These embodiments about QDs demonstrate that the filtration displays very high efficiency for smaller sized QDs, due to few larger sized QDs blocked on the supramolecular polymer membrane as the residue.

Separation of QDs mixture solution (1) by Te-membrane: 1-Thioglycerol decorated CdTe QDs (0.1 mL, 10 mM, λₘₐₓ=533 nm with green emission, D=3.3 nm) and 1-thioglycerol decorated CdTe QDs (0.4 mL, 5 mM, λₘₐₓ=611 nm with red emission, D=4.4 nm) were added into water (19.5 mL) to obtain QDs mixture solution (1). The mixture solution was filtered by the as-prepared Te-membrane and fluorescence spectrum was used to detect the fluorescence change of QDs mixture solution (1) before and after filtering through Te-membrane (FIG. 24). After filtration, the fluorescence spectrum of the filtrate shows only one emission band (λₘₐₓ=533 nm, D=3.3 nm) with a separation efficiency of 81.3%, indicative of which only the QDs with small size have passed through the Te-membrane, while the large size part were blocked by the membrane.

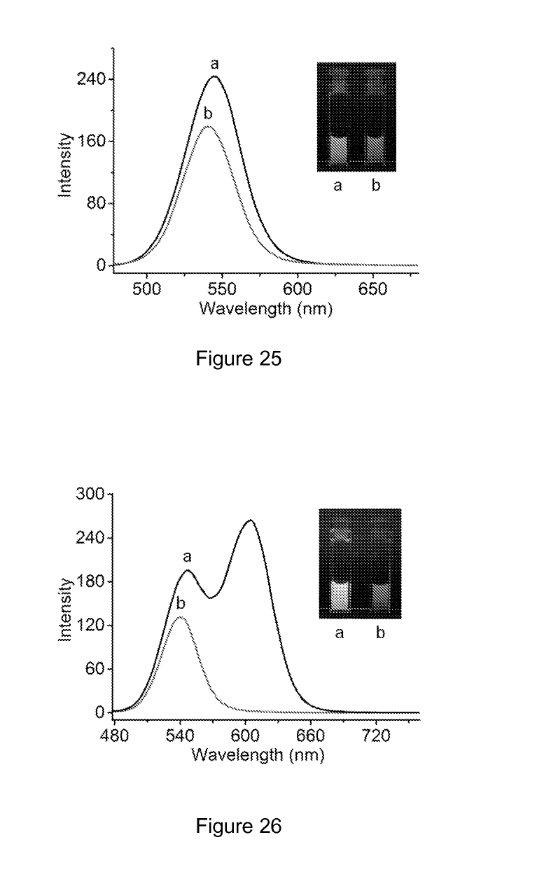

Separation of QDs solution (7) by Te-membrane: 3-Mercaptopropionic acid decorated CdTe QDs (0.05 mL, 10 mM, λₘₐₓ=545 nm with green emission, D=4.0 nm) was added into water (19.95 mL) to obtain QDs solution (7). The solution was filtered by the as-prepared Te-membrane and fluorescence spectrum was used to detect the fluorescence change of QDs solution (7) before and after filtering through Te-membrane (FIG. 25). After filtration, a 5-nm blue-shifting (λₘₐₓ=540 nm, D=3.9 nm) of the emission band occurs in the filtrate with a separation efficiency of 80.4%, indicative of which only the QDs with small size have passed through the Te-membrane, while the large size part were blocked by the membrane.

Separation of QDs mixture solution (8) by Te-membrane: 3-Mercaptopropionic acid decorated CdTe QDs (0.02 mL, 10 mM, λₘₐₓ=545 nm with green emission, D=4.0 nm) and 1-thioglycerol decorated CdTe QDs (0.2 mL, 5 mM, λₘₐₓ=611 nm with red emission, D=4.4 nm) was added into water (19.78 mL) to obtain QDs mixture solution (8). The mixture solution was filtered by the as-prepared Te-membrane and fluorescence spectrum was used to detect the fluorescence change of QDs mixture solution (8) before and after filtering through Te-membrane (FIG. 26). After filtration, After filtration, the photographs show the orange luminescence turns green; furthermore, a 5-nm blue-shifting (λₘₐₓ=540 nm, D=3.9 nm) of the emission band occurs in the filtrate with a separation efficiency of 71.2%, indicative of which only the QDs with small size have passed through the Te-membrane, while the large size part were blocked by the membrane.

Many embodiments of the disclosure have been described. Nevertheless, it will be understood that various modifications may be made without departing from the spirit and scope of the disclosure. Accordingly, other embodiments are within the scope of the following claims.

What is claimed is:

1. A flexible 2D single-layer supramolecular polymer comprising the general structure [L]²⁺[POM]^{∝-}[L]²⁻, wherein POM is a polyoxometalate, and L is a bridging sick which comprises a host α-cyclodextrin (CD) and Formula I (bolaform cationic molecule): 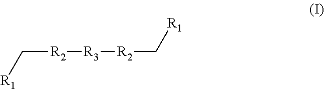
Wherein, R₁ is a cationic group; R₂ is a guest group; R₃ is a linker.

2. The flexible 2D single-layer supramolecular polymer of claim 1, wherein POM is a Keggin-type polyoxometalate or a polyoxometalate with similar size, which has four negative charges, for example [SiW₁₂O₄₀]⁴⁻, [SiMo₁₂O₄₀]⁴⁻, [SiW₁Mo₁₁O₄₀]⁴⁻, [SiW₂Mo₁₀O₄₀]⁴⁻, [SiW₃Mo₉O₄₀]⁴⁻, [SiW₄Mo₈O₄₀]⁴⁻, [SiW₆Mo₆O₄₀]⁴⁻, [SiW₁₁Mo₁O₄₀]⁴⁻, [SiW₁₀Mo₂O₄₀]⁴⁻, [SiW₉Mo₃O₄₀]⁴⁻, [GeW₁₂O₄₀]⁴⁻, [GeMo₁₂O₄₀]⁴⁻, [PW₁₁VO₄₀]⁴⁻, [PMo₁₁VO₄₀]⁴⁻, α-[PW₁₁O₃₉Cr^{III}(H₂O)]⁴⁻, α-[PW₁₁O₃₉Cr^{III}(H₂O)]⁴⁻, α-[PW₁₁O₃₉Cr^{V}O]⁴⁻, α-[PW₁₁O₃₉Mn^{III}(H₂O)]⁴⁻, α-[PW₁₁O₃₉Co^{III}(H₂O)]⁴⁰⁻, α-[PW₁₁O₃₉Co^{III}(pyridine)]⁴⁻.

3. The flexible 2D single-layer supramolecular polymer of claim 2, wherein the cation of the POM is proton, ammonium or alkali metal ion.

4. The flexible 2D single-layer supramolecular polymer of claim 2, wherein POM is either K₄[PW₁₁VO₄₀] or H₄[PMo₁₁VO₄₀].

5. The flexible 2D single-layer supramolecular polymer of claim 1, wherein R₁ is selected from —NH₃⁻, —[NH₂(CH₃)]⁺, —[NH(CH₃)₂]⁺, —[N(CH₃)₃]⁺,

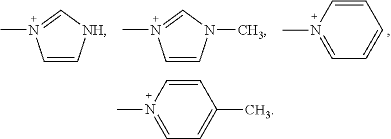

6. The flexible 2D single-layer supramolecular polymer of claim 5, wherein the counter ion of the R₁ is selected from Cl⁻, Br⁻, I⁻, PF₆⁻,

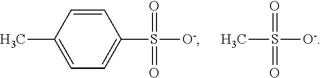

7. The flexible 2D single-layer supramolecular polymer of claim 5, wherein R₁ is

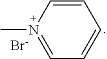

8. The flexible 2D single-layer supramolecular polymer of claim 1, wherein R₂ is selected from

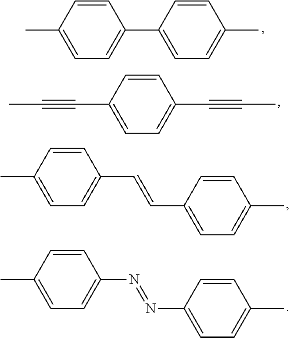

9. The flexible 2D single-layer supramolecular polymer of claim 8, wherein R₂ is

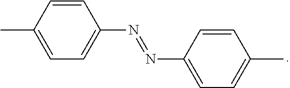

10. The flexible 2D single-layer supramolecular polymer of claim 1, wherein R₃ is selected from 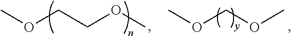
and n is a number from 0 to 7 and y is a number from 0 to 14.

11. The flexible 2D single-layer supramolecular polymer of claim 10, wherein R₃ is 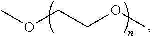
and n is a number either 3 or 4.

12. The flexible 2D single-layer supramolecular polymer of claim 1, wherein the linker increases the flexibility of the 2D single-layer supramolecular polymers.

13. The flexible 2D single-layer supramolecular polymer of claim 1, wherein CD blocks the possible aggregation and controls the space adaptation of four bolaform cationic molecule around one POM in a 2D plane.

14. The flexible 2D single-layer supramolecular polymer of claim 1, wherein CD increases the solubility of the 2D single-layer supramolecular polymer in water.

15. The method of making the flexible 2D single-layer supramolecular polymer of claim 1 comprises a reaction at RT comprising water, POM, and a bridging sick which comprises a reaction at RT comprising water, CD and Formula I (bolaform cationic molecule) under sonication: 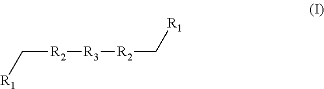
Wherein, R₁ is a cationic group; R₂ is a guest group; R₃ is a linker.

16. A method of making the membrane based on the flexible 2D single-layer supramolecular polymer of claim 1 comprises a facile suction filtration procedure using a supporting filter.

17. The method of claim 16 wherein the supporting filter is an aqueous membrane with pore size from 100 to 400 nm, but with no limitations to its material.

18. The method of claim 16 wherein the area of the membranes is not restricted and the membranes can be prepared in any shape and size.

19. A method of nano-size separation of one or more chemicals from a solution or mixture by using the membrane of claim 16.

20. The method of claim 19 wherein the chemical is an organic molecule.

21. The method of claim 19 wherein the chemical is an inorganic molecule.
